(19) United States
(12) Patent Application Publication
(10) Pub. No.: US 2015/0193386 A1
(43) Pub. Date: Jul. 9, 2015

(54) System and Method of Facilitating Font Selection and Manipulation of Fonts

(71) Applicants: David Adam Wurtz, Boulder, CO (US); David J. Kuettel, San Jose, CA (US); Jeremie Lenfant-Engelmann, San Francisco, CA (US); Brian Kromrey, San Mateo, CA (US); Marc Tobias Kunisch, London (GB); Raphael Linus Levien, Berkeley, CA (US); Dave Peter Crossland, Wimborne (GB); Steven Lee Goldberg, San Carlos, CA (US); John Palacios, Seattle, WA (US); Kim Michael Alexander, Seattle, WA (US); Dawn Shaikh, Bellevue, WA (US)

(72) Inventors: David Adam Wurtz, Boulder, CO (US); David J. Kuettel, San Jose, CA (US); Jeremie Lenfant-Engelmann, San Francisco, CA (US); Brian Kromrey, San Mateo, CA (US); Marc Tobias Kunisch, London (GB); Raphael Linus Levien, Berkeley, CA (US); Dave Peter Crossland, Wimborne (GB); Steven Lee Goldberg, San Carlos, CA (US); John Palacios, Seattle, WA (US); Kim Michael Alexander, Seattle, WA (US); Dawn Shaikh, Bellevue, WA (US)

(21) Appl. No.: 13/463,491

(22) Filed: May 3, 2012

(51) Int. Cl. G06F 17/21; G06F 17/22

(52) U.S. Cl. CPC G06F 17/214; G06F 17/2247

(57) ABSTRACT

A text rendered using a first font in a first region of a display, and the text rendered using a second font in a second region of the display, are displayed simultaneously on a webpage. An option to manipulate the text rendered using the first font and the text rendered using the second font is provided. In response to a selection of the option, the text rendered using the first font and the text rendered using the second font are manipulated. A code associated with a style sheet corresponding to a selected one of the first font and the second font is generated.

### TECHNICAL FIELD

This specification relates generally to systems, methods and apparatus for facilitating font selection, and more particularly to systems, methods and apparatus for facilitating selection of a font for use on a webpage.

### BACKGROUND

Existing webfont service providers allow web developers to use selected webfonts on a website. Webfonts include fonts hosted by a service provider that can be accessed by a website developer for use on a website. For example, a service provider may enable a web developer who is building a website to access and download selected webfonts onto the developer's computer and/or server. The developer may then use the downloaded fonts on the website.

### BRIEF SUMMARY

In accordance with an embodiment, a text rendered using a first font in a first region of a display, and the text rendered using a second font in a second region of the display, are displayed simultaneously on a webpage. An option to manipulate the text rendered using the first font and the text rendered using the second font is provided. In response to a selection of the option, the text rendered using the first font and the text rendered using the second font are manipulated. A code associated with a style sheet corresponding to a selected one of the first font and the second font is generated.

In one embodiment, the option to manipulate text includes at least one of: changing the size of the text rendered using the first font and the text rendered using the second font, changing a letter spacing associated with the text rendered using the first font and the text rendered using the second font, changing a word spacing associated with the text rendered using the first font and the text rendered using the second font, changing a line height associated with the text rendered using the first font and the text rendered using the second font, underlining the text rendered using the first font and the text rendered using the second font, changing the text rendered using the first font and the text rendered using the second font from one line to a paragraph, changing the text rendered using the first font and the text rendered using the second font from a paragraph to a line, and selecting a script associated with the text rendered using the first font and the text rendered using the second font.

In another embodiment, a character set text rendered using the first font adjacent the character set text rendered using the second font is displayed. A description associated with the first font and a description associated with the second font may be displayed in response to input instructions.

In accordance with an embodiment, the text includes one of a predetermined phrase and a dynamically generated phrase. For example, the dynamically generated phrase may be received, and in response to receiving the dynamically generated phrase, the dynamically generated phrase rendered using the first font may be displayed in a third region of the webpage, and the dynamically generated phrase rendered using the second font may be displayed in a fourth region of the webpage.

In another embodiment, a second text may be rendered in a third region using at least one of the first font and the second font. The second text may include at least one of a single word, a single heading, a single sentence, and a paragraph.

In another embodiment, a style associated with one of the first font or the second font may be displayed.

These and other advantages of the invention will be apparent to those of ordinary skill in the art by reference to the following detailed description and the accompanying drawings.

### BRIEF DESCRIPTION OF THE DRAWINGS

FIG. 1 illustratively depicts a communication system in accordance with an embodiment;

FIG. 2 illustratively depicts functional components of an exemplary web developer device in accordance with an embodiment;

FIG. 3 illustratively depicts functional components of an exemplary end user device in accordance with an embodiment;

FIG. 4 illustratively depicts functional components of an exemplary webfont server in accordance with an embodiment;

FIG. 5 illustratively depicts a flowchart of a method for displaying a plurality of fonts on a webpage in accordance with an embodiment;

FIG. 6 illustratively depicts a plurality of fonts displayed on a webpage in accordance with an embodiment;

FIG. 7 illustratively depicts a plurality of fonts displayed on a webpage in accordance with an embodiment;

FIG. 8 illustratively depicts a plurality of fonts displayed on a webpage in accordance with an embodiment;

FIG. 9 illustratively depicts a flowchart of a method for displaying a plurality of fonts on a webpage in accordance with an embodiment;

FIG. 10A illustratively depicts a plurality of fonts displayed on a webpage in accordance with an embodiment;

FIG. 10B illustratively depicts a plurality of fonts displayed on a webpage in accordance with an embodiment;

FIG. 11 illustratively depicts a plurality of fonts displayed on a webpage in accordance with an embodiment;

FIG. 12A illustratively depicts a webpage containing a plurality of font selection options and a load time indicator in accordance with an embodiment;

FIG. 12B illustratively depicts a webpage containing a plurality of font selection options and a load time indicator in accordance with an embodiment;

FIG. 13 illustratively depicts a flowchart of a method of determining an estimated load time in accordance with an embodiment;

FIG. 14 illustratively depicts a flowchart of a method for providing font data to a device in accordance with an embodiment;

FIG. 15A illustratively depicts a website's HTML code in accordance with an embodiment;

FIG. 15B illustratively depicts a file containing information relating to selected fonts in accordance with an embodiment;

FIG. 16A illustratively depicts a page of a website in accordance with an embodiment;

FIG. 16B illustratively depicts the website page of FIG. 16A after selected fonts have been loaded in accordance with an embodiment;

FIG. 17 illustratively depicts different font data associated with various devices in accordance with an embodiment; and

FIG. 18 illustratively depicts components of a computer that may be used to implement the invention.

### DETAILED DESCRIPTION

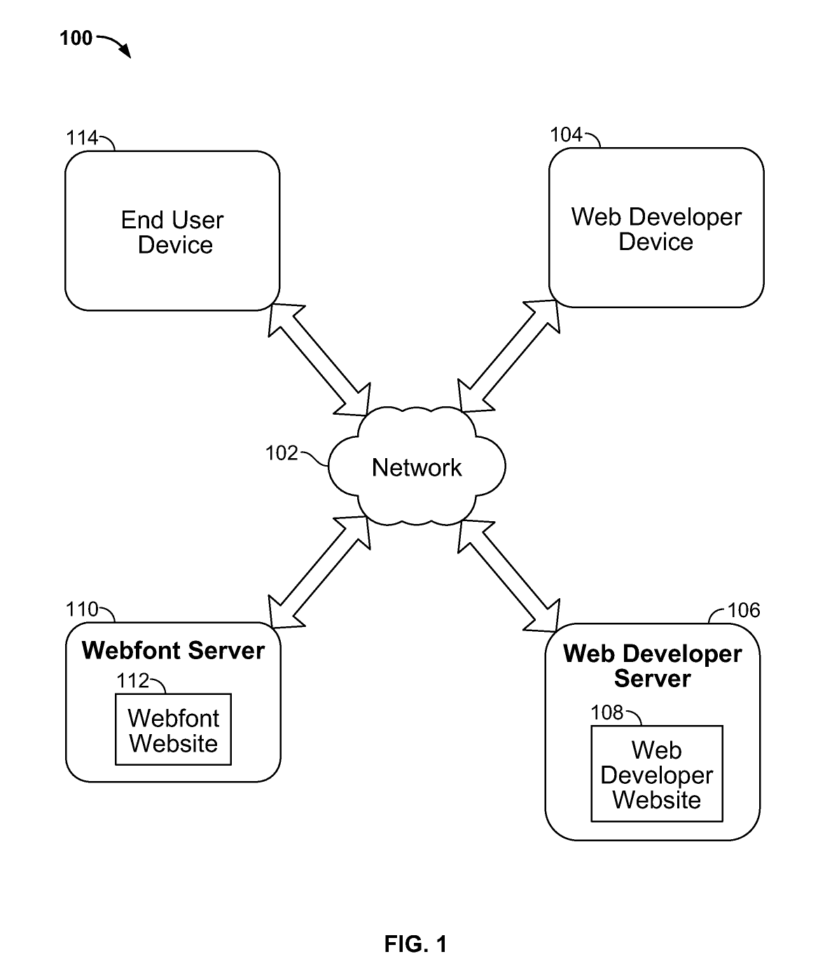

FIG. 1 shows a communication system 100, according to an embodiment. Communication system 100 includes a web developer device 104, a web developer server 106, a webfont server 110 and an end user device 114. These devices and/or servers communicate with each other using network 102.

In the exemplary embodiment of FIG. 1, network 102 is the Internet. In other embodiments, network 102 may include one or more of a number of different types of networks, such as, for example, an intranet, a local area network (LAN), a wide area network (WAN), a wireless network, a Fibre Channel-based storage area network (SAN), or Ethernet. Other networks may be used. Alternatively, network 102 may include a combination of different types of networks.

Webfont server 110 maintains, and makes available to developers, a plurality of fonts that may be used, for example, to display text on a webpage. Webfont server 110 may maintain a webfont website 112 which may be used by developers to access the available fonts. Webfont website 112 may be hosted on webfont server 110 or may be hosted externally (not shown).

Web developer server 106 maintains a web developer website 108. In an illustrative embodiment, web developer device 104 is used by a web developer to build one or more webpages on web developer website 108.

According to an embodiment, when a web developer accesses webfont server 110 and selects the fonts he/she wishes to use on website 108, the developer may receive a code to include on website 108. The code may include a link to a font file including font data defining the selected fonts; the font file may be stored at webfont server 110 or at another server. Subsequently, when an end user device, such as end user device 114, views and/or otherwise accesses website 108, end user device 114 may obtain the code and use the code to access the selected fonts at webfont server 110. After obtaining the fonts, end user device 114 may display text contained within website 108 using the selected fonts.

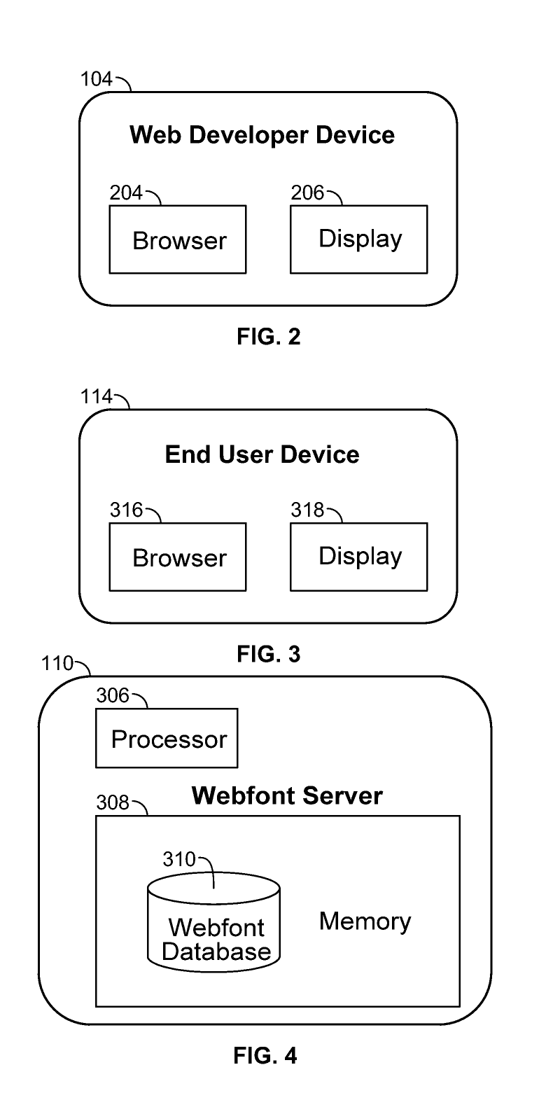

FIG. 2 shows functional components of web developer device 104 in accordance with an embodiment. Web developer device 104 includes a browser 204 and a display 206. Browser 204 may be a conventional web browser used to access World Wide Web sites via the Internet, for example. Display 206 displays webpages, images and other information. For example, a web developer may use display 206 to view webfont website 112 and select one or more fonts for use on a webpage.

FIG. 3 shows functional components of an exemplary end user device 114 in accordance with an embodiment. End user device 114 includes a browser 316 and a display 318. Browser 316 may be a conventional web browser used to access World Wide Web sites via the Internet, for example. Display 318 displays webpages, images and other information. For example, an end user employing end user device 114 may use display 318 to view and/or otherwise access web developer website 108.

FIG. 4 shows functional components of an exemplary webfont server 110 in accordance with an embodiment. Webfont server 110 includes a processor 306 and a memory 308. Webfont server 110 may include other components not shown in FIG. 4. In an exemplary embodiment, a plurality of fonts and related font data are stored in webfont database 310 within memory 308. In an alternative embodiment, fonts and font data may be stored in external memory located remote from webfont server 110.

In accordance with an embodiment, data related to each font stored in webfont database 310 includes data related to the particular font and other features associated with the particular font, such as one or more styles (“Italic,” “Bold,” etc.), one or more scripts (Latin, Cyrillic, etc.), one or more sizes, etc. Accordingly, webfont database 310 stores, for each font, font data that defines the font and the associated styles, scripts, sizes, etc.

In accordance with an embodiment, a web developer who is building website 108 may access and view the fonts maintained by webfont server 110 and select one or more fonts for use on the website. For example, suppose that a web developer is developing and/or designing a webpage on website 108 that relates to silly monkeys. The developer wishes to use several different fonts to render text on the webpage. In order to find fonts appropriate for the webpage, and prior to selecting any fonts, it is beneficial to view sample text rendered using various available fonts. Referring to FIG. 1, the developer may employ web developer device 104 to access webfont website 112, and browse, view and select from a variety of different fonts.

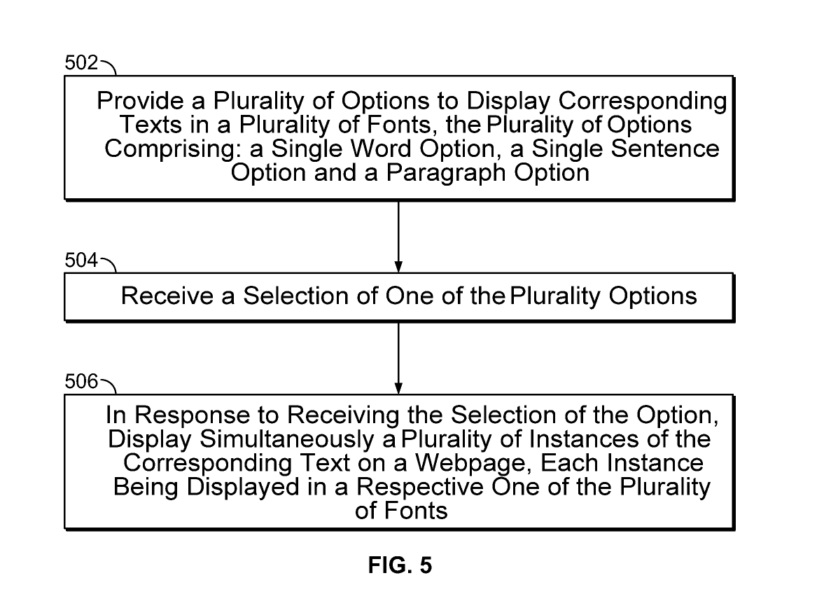

FIG. 5 is a flowchart of a method for displaying a plurality of fonts in accordance with an embodiment. At step 502, a plurality of options to display corresponding texts in a plurality of fonts are provided by webfont server 110 via webfont website 112. The plurality of options include: a single word option, a single sentence option and a paragraph option.

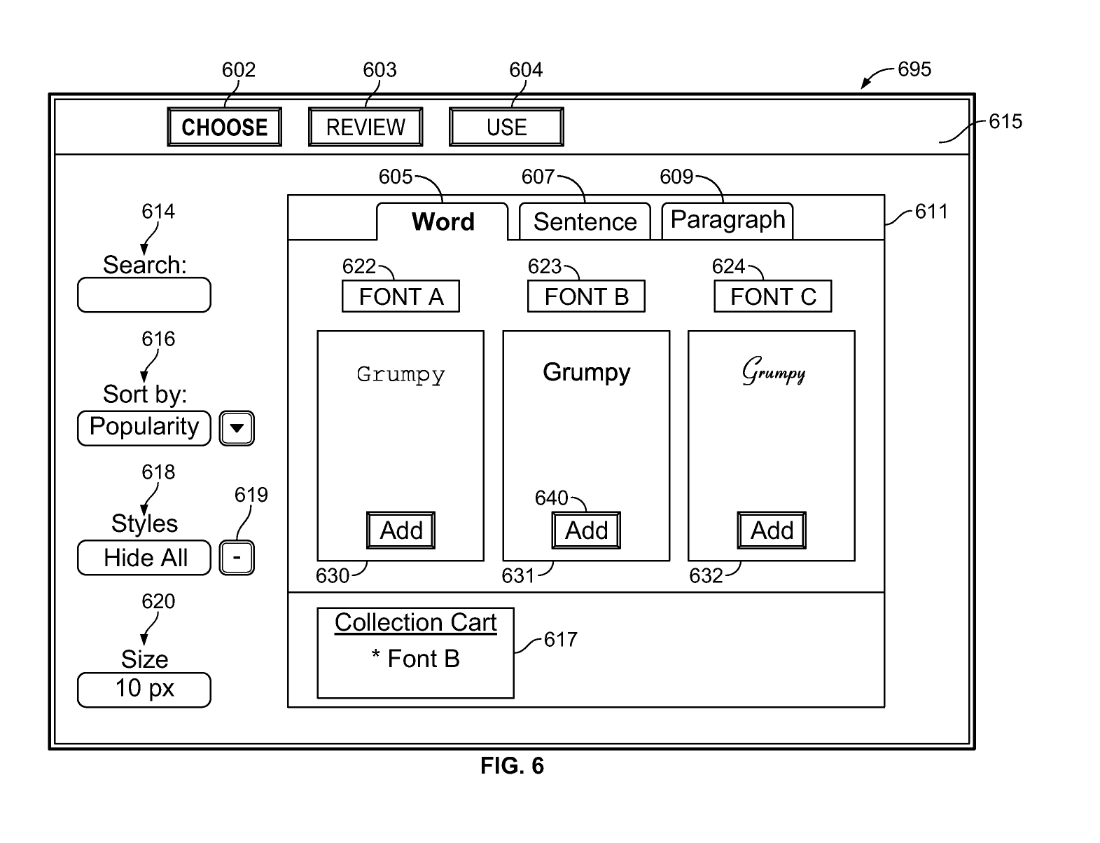

In the illustrative embodiment, when the developer accesses webfont website 112, a webpage such as that shown in FIG. 6 is displayed. FIG. 6 shows plurality of fonts displayed on a webpage 695 in accordance with an embodiment. A plurality of fonts may be displayed by default, in accordance to an embodiment. In this example, a plurality of fonts including Font A 622, Font B 623, and Font C 624 are provided on webpage 695. Alternatively, a developer may be provided with a list of fonts from which the developer can select one or more fonts. Of course, there may be additional available fonts (or fewer fonts) presented to the developer and the three fonts are provided for exemplary purposes only.

Webpage 695 includes a pane 615, which includes a choose button 602, a review button 603 and a use button 604. A developer may select choose button 602 to choose one or more fonts; review button 603 to review how the selected fonts are presented; and use button 604 to use the selected fonts on his/her web site. Of course, the developer may toggle back and forth between these buttons and may skip over one of the choose, review or use steps. Further, the developer may make a selection of choose button 602, review button 603, and use button 604 in any order or may wish to not use one of the buttons. For example, a developer may select choose button 602 to select the fonts and skip directly to using the fonts by selection of use button 604.

In the illustrative embodiment, the developer may select choose button 602 from pane 615; in response, a pane 611 including a plurality of options 605, 607, 609 for displaying corresponding texts is provided. In one embodiment, pane 615 is optional and the web developer may view and/or otherwise access pane 611 without the use of pane 615.

Pane 611 includes word tab 605, a sentence tab 607 and a paragraph tab 609. If a developer wishes to view a single word rendered using various fonts, word tab 605 may be selected. At step 504, a selection of one of the plurality of options is received. Supposing that the developer selects word tab 605, the developer's selection is received by webfont server 110 via network 102. A request is sent by webfont server 110 to display text in the form of a single word rendered using one or more fonts.

At step 506, in response to receiving the selection of the option, a plurality of instances of the corresponding text are displayed simultaneously on a webpage. Each instance is displayed in a respective one of the plurality of fonts. Thus, webfont server 110 causes web developer device 114 to display multiple instances of a word using the one or more fonts on webpage 695. Referring to FIG. 6, webfont server 110 displays the word “Grumpy” in region 630 in the first font (Font A), in region 631 in the second font (Font B) and in region 632 in the third font (Font C).

In an embodiment, the developer may select a plurality of fonts. For example, the developer may select multiple fonts from a list consisting of Font A 622, Font B 623 and Font C 624. In response, webfont server 110 generates the subset to display on webfont website 112. In an embodiment, receiving the request to generate the subset and generating the subset by the webfont server 110 are performed substantially in real-time. For example, the developer may select Font A 622 and Font C 624. In response to receiving the developer's selection, the webfont server 110 generates a subset containing Font A 622 and Font C 624 and updates webfont website 112 substantially in real time, where text is rendered using Font A 622 and Font C 624. The developer is then able to view text rendered using Font A 622 and Font C 624.

The fonts shown in FIG. 6 are provided for exemplary purposes only; in other embodiments, fonts other than those shown in FIG. 6 may be used. Further, additional (or fewer) fonts than the ones shown in FIG. 6 may be presented.

Alternatively, a developer may be provided with pane 611 by default when the developer accesses webfont website 112, without selecting word tab 605 (e.g. by clicking on and/or otherwise selecting word tab 605).

In one embodiment, a developer may choose to exclude one or more fonts for viewing. For example, the developer may choose a subset of styles of fonts and any fonts that are consequently not included within the subset, will not be displayed.

In the illustrative embodiment of FIG. 6, a sort field 616, a search field 614, a styles field 618 and a size field 620 are also displayed, to the left of pane 611. In one embodiment, a developer may use sort field 616 to sort the displayed fonts based on a selected parameter. For example, a developer may wish to view the most popular fonts first by selecting a “popularity” parameter from a drop-down menu. Additional sorting parameters include alphabetical order, newly added, number of styles, trending, etc. Other sorting options may be provided. When webfont server 110 receives a request from web developer device 104 to perform a sort function, webfont server 110 sorts the displayed fonts based on the request. The sorted fonts are then displayed on webfont website 112.

In one embodiment, a developer may use the search field 614 to search for a particular font by font name, description, etc.

In one embodiment, a developer may use styles field 618 to display all styles associated with the displayed fonts. The developer may then select a font style. Some styles may include “Italic,” “Bold,” “Extra-Bold Italic,” “Italic Bold,” “Semi-Bold,” “Semi-Bold Italic,” “Ultra-Light,” “Ultra-Light Italic,” “Medium,” “Medium Italic,” “Book,” “Book Italic,” etc. In one embodiment, the developer may toggle between hiding all styles and showing all styles using toggle button 619.

Other options (not shown) that may be provided include filtering the fonts by thickness, slant, width, serif, sans-serif, handwriting, etc. A developer may further examine scripts associated with selected fonts. For example, a font may include the following scripts: Latin, Latin Extended, Cyrillic, Cyrillic Extended, Greek, Greek Extended, Khmer, Vietnamese, etc.

A developer may use size field 620 to change the font size of all the text displayed. For example, referring to FIG. 6, the developer may change the size of text displayed in regions 630, 631 and 632 by selecting a 10 pixel font size. Upon receiving a request from web developer device 104 via webfont website 112 to change the text size (e.g. 10 pixels), webfont server 110 transmits updated font sizes for all of the text displayed on webfont website 112. The transmission may be performed substantially simultaneously after receiving the request. In one embodiment, a region may display one or more fonts. Additionally, the three regions in FIG. 6 are shown for exemplary purposes only and additional (or fewer) regions and/or additional (or fewer) fonts may be provided.

The developer may view and compare a selected text (in the illustrative embodiment, text containing a single word) rendered using a plurality of fonts side by side or one above another. In this way, the developer may preview text rendered using the font(s) prior to selecting which font(s) to use on a website.

When the developer has made a decision as to what font(s) the developer wishes to use on the developer's website, the developer may select the font(s) by adding them to a collection cart 617, shown in FIG. 6. Referring again to the illustrative embodiment, should the developer wish to select Font B 623, the developer may click on add button 640 in region 631 to add Font B 623 to collection cart 617. When webfont server 110 receives the selection of Font B 623, webfont server 110 adds Font B 623 to collection cart 617 and displays Font B in collection cart 617, as shown in FIG. 6. A developer may add one or more fonts to collection cart 617.

In the embodiment of FIG. 6, pane 611 also includes a sentence tab 607 and a paragraph tab 609. By selecting sentence tab 607 or paragraph tab 609, a developer may view a sentence or a paragraph, rendered in a plurality of fonts.

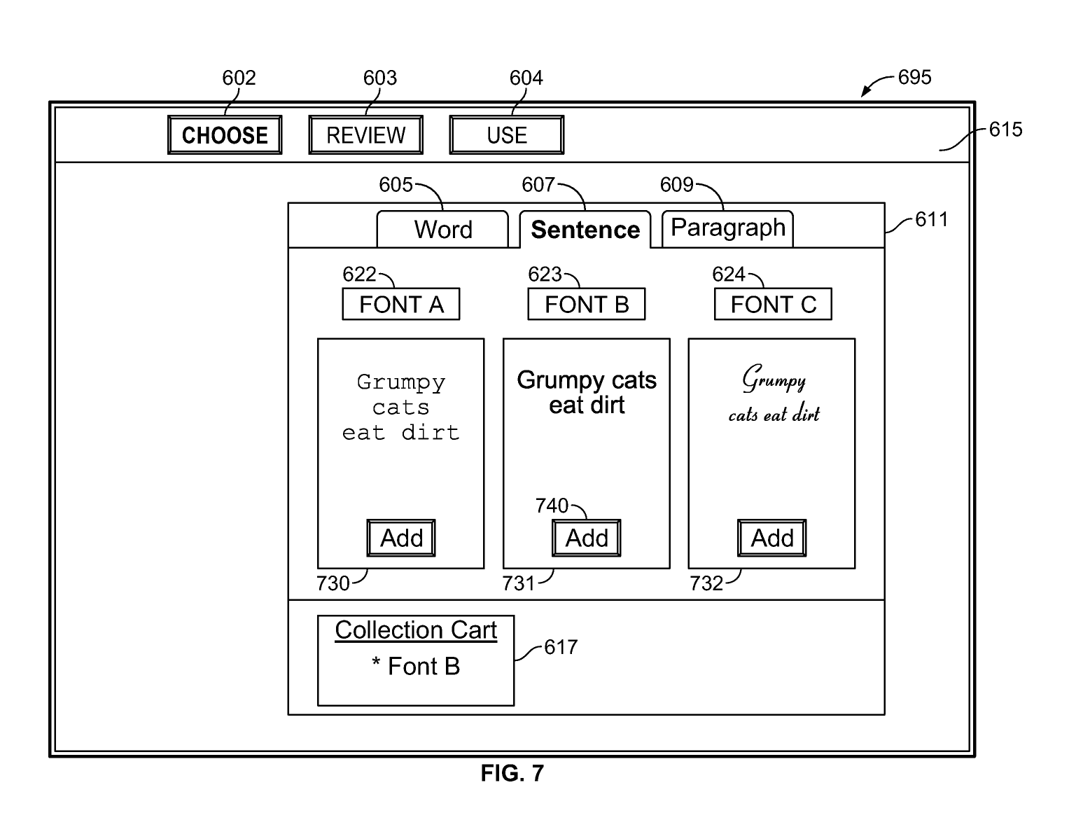

Suppose now that a developer wishes to view a sentence rendered in Font A, Font B and Font C to further compare the fonts. The developer may therefore select sentence tab 607. In response to the selection, webfont server 110 causes a sentence to be displayed in a plurality of fonts, as shown in FIG. 7. FIG. 7 shows a plurality of fonts displayed on a webpage in accordance with an embodiment. More specifically, FIG. 7 shows webpage 695 on which a single sentence, “Grumpy Cats Eat Dirt,” is rendered using a plurality of fonts. In one embodiment, when sentence tab 607 is selected, the text displayed within regions 630, 631 and 632, as shown in FIG. 6, is dynamically transformed into text contained within regions 730, 731 and 732.

The sentence “Grumpy cats eat dirt” is shown for exemplary purposes; in other embodiments, other predetermined sentences or sentences input by the developer may be used. Further, regions 730, 731 and 732 shown in FIG. 7 contain an outline for exemplary purposes only; in other embodiments, the outline is not visible. Alternatively, regions 730, 731 and 732 may be visually outlined to help distinguish between the different fonts applied to text containing a single sentence.

A developer may view and compare text (e.g. text containing a single sentence) rendered using a plurality of fonts side by side or one above another. In this way, the developer may preview text rendered using the font(s) before deciding which font(s) to use on his/her website.

As discussed above, when the developer has made a decision as to what font(s) the developer wishes to use on the developer's website, the developer may add the selected font(s) to collection cart 617.

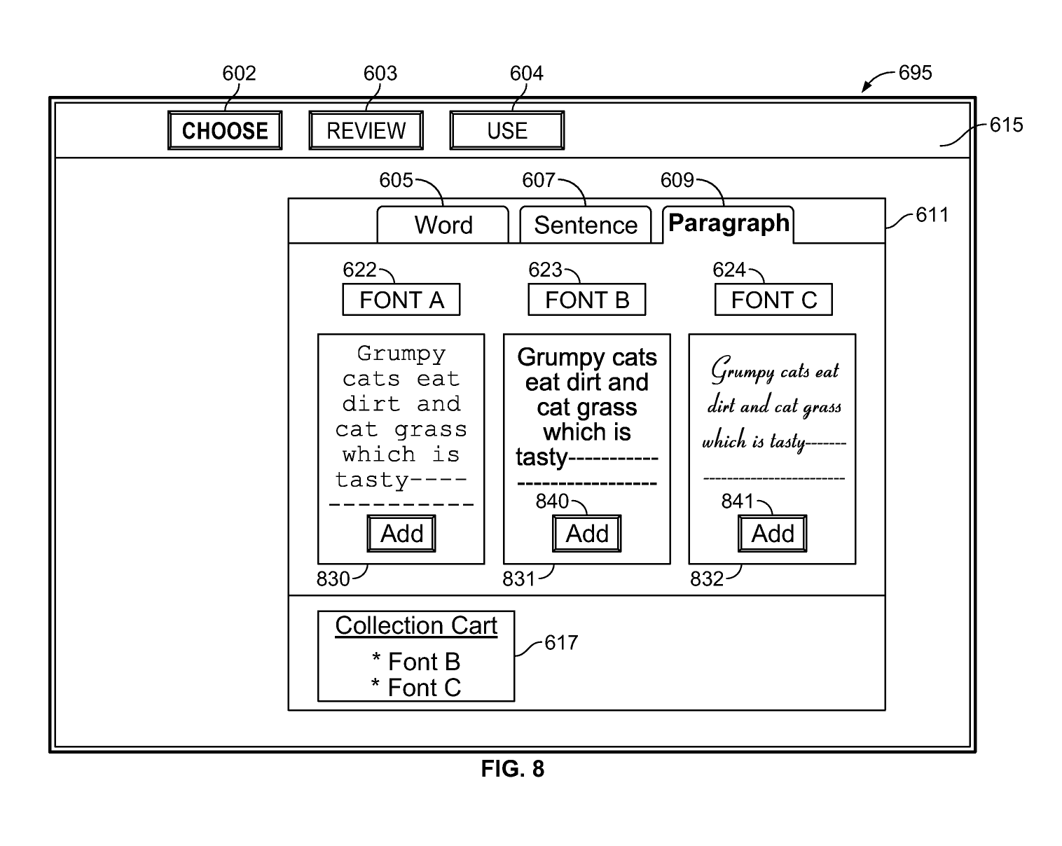

Suppose now that the developer wishes to view a paragraph rendered in Font A, Font B, and in Font C. The developer accordingly selects paragraph tab 609. In response, webfont server 110 causes a paragraph to be displayed in the three selected fonts, as shown in FIG. 8.

FIG. 8 shows a plurality of fonts displayed on webpage 695 in accordance with an embodiment. More specifically, FIG. 8 shows pane 611 in which a paragraph is rendered using Font A 622, Font B 623 and Font C 624.

In the illustrative embodiment, regions 830, 831 and 832 display a paragraph “Grumpy cats eat dirt and cat grass which is tasty . . . ” rendered using Font A 622, Font B 623 and Font C 624, respectively. The paragraph “Grumpy cats eat dirt and cat grass which is tasty . . . ” is shown for exemplary purposes; in other embodiments, other predetermined paragraphs or paragraphs input by the developer may be used. Further, regions 830, 831 and 832 contain an outline for exemplary purposes only. Alternatively, regions 830, 831 and 832 may be visually outlined to help distinguish between the different fonts applied to text contained within a single word.

The developer may view and compare text (e.g. a paragraph) rendered using a plurality of fonts side by side or one above another on website 695. In this way, the developer may preview text rendered using the font(s) before deciding which font(s) to use on the website.

When the developer has made a decision as to what font(s) to use on a website, the developer may add the font(s) to collection cart 617. In the illustrative example, supposing that the developer decides to use Font C 624, the developer may click on an add button 841 in region 832 to add Font C 624 to collection cart 617. Font C now appears in collection cart 617, as shown in FIG. 8. Other fonts may be added to collection cart 617.

Having the option of viewing how a single word, a single sentence and a paragraph, appear when rendered using different fonts, as shown in FIGS. 6, 7 and 8, advantageously provides a developer with a great deal of flexibility in viewing the appearance of the fonts prior to selecting the font for use on a website.

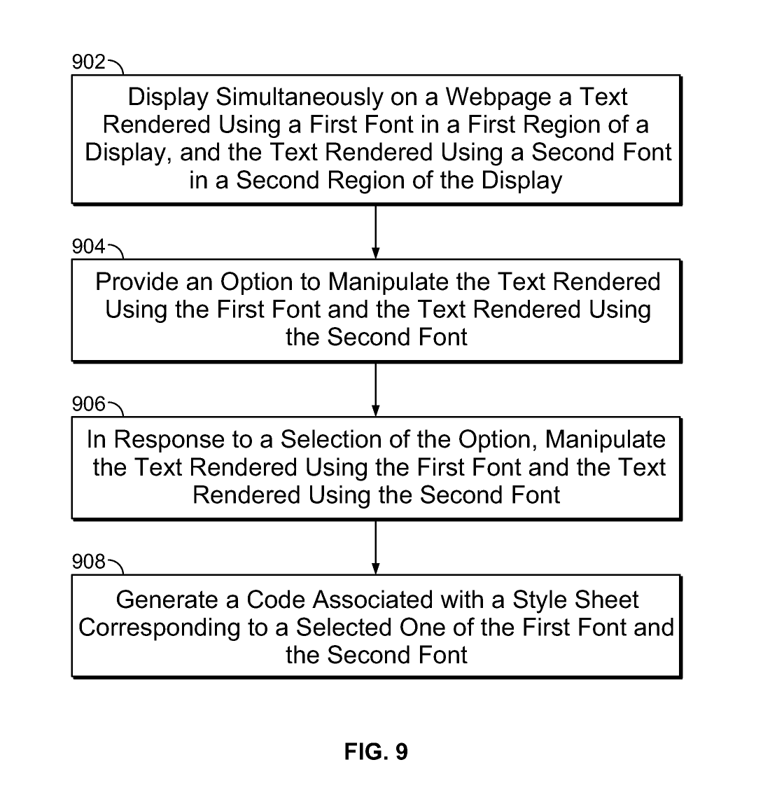

After selecting one or more fonts and adding them to collection cart 617, a developer may further manipulate the fonts. FIG. 9 shows a flowchart of a method for displaying text using a plurality of fonts on a webpage in accordance with an embodiment.

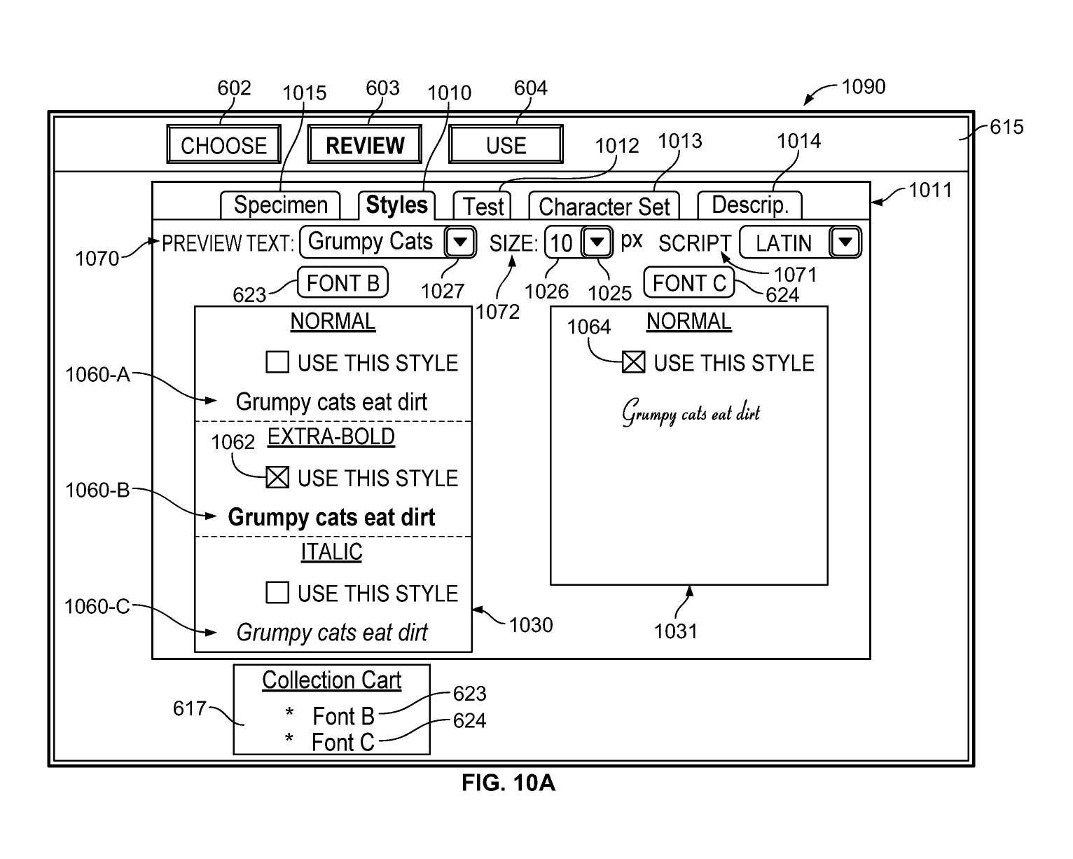

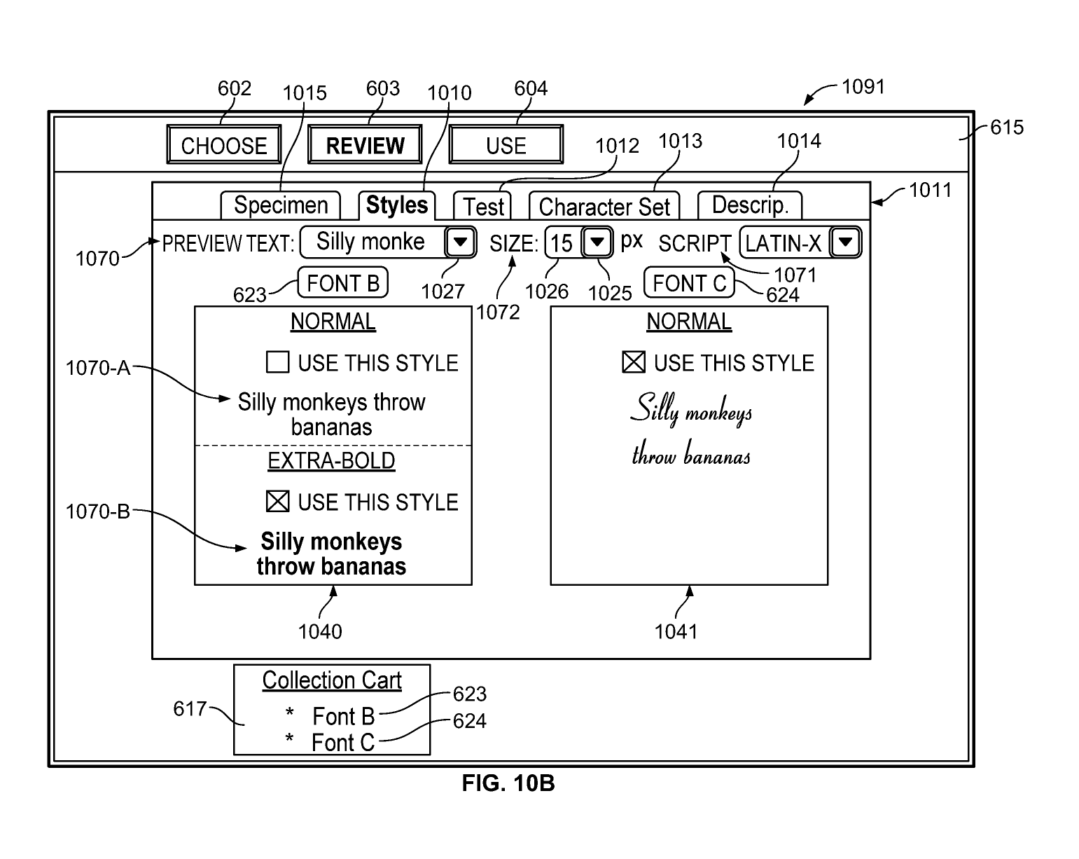

Referring to FIG. 8, a developer may select review button 603 in pane 615 to further manipulate the fonts that have been placed in collect cart 617. For example, if review button 603 is selected, the developer may be provided with various options, shown by FIG. 8. In the illustrative embodiment, supposing that the developer now wishes to view and manipulate Font B and Font C, the developer may select review button 603; webfont server 110 receives the selection and, in response, causes a webpage 1090 to be displayed on web developer device 104, as shown in FIG. 10A. In an alternate embodiment, the webpage may automatically be displayed upon adding two or more fonts to collection cart 617.

At step 902, a text rendered using a first font in a first region of a display, and the text rendered using a second font in a second region of the display, are simultaneously displayed on a website. On webpage 1090, webfont server 110 displays the fonts within collection cart 617. Specifically, text rendered using Font B 623 is displayed in a first region 1030 and text rendered using Font C 624 is displayed in a second region 1031. Regions 1030 and 1031 are displayed simultaneously. A text “Grumpy cats eat dirt” is rendered in first region 1030 using Font B 623. The same text is rendered within second region 1031 using Font C 624.

At step 904, an option is provided to manipulate the text rendered using the first font and the text rendered using the second font. Referring to FIG. 10A, several options to manipulate the text rendered using the first font and the text rendered using the second font are provided, including, for example, a preview text option 1070, a size option 1072 and a script option 1071. Such manipulation techniques are discussed in detail below.

At step 906, in response to a selection of the option, the text rendered in the first font and the text rendered in the second font are manipulated. Supposing that a developer selects one of the options, in response to the selection of the option, webfont server 110 manipulates the text rendered using the first font and the text rendered using the second font. For example, by selecting size option 1072, the size of the texts may be manipulated.

At step 908, a code associated with a style sheet corresponding to a selected one of the first font and the second font is generated. Supposing that the developer now selects one of the first font and second font, webfont server 110 generates a code associated with a style sheet corresponding to the selected font.

It has been observed that many websites use only some of the available styles associated with a font, some of the available sizes associated with a font, etc. Therefore, providing to a user device font data that includes all of the styles, sizes, and other features associated with a font may be inefficient and undesirable.

In accordance with an embodiment, a developer may manipulate selected fonts within region 1030 and 1031 and select a subset of styles, sizes, or other characteristics associated with the selected fonts that the developer wishes to use on a website. For example, a developer may select a subset of styles associated with a font, a subset of sizes associated with a font, etc.

Referring to FIG. 10A, a plurality of styles associated with a particular font may be displayed. For example, in first region 1030 text samples 1060-A, 1060-B and 1060-C rendered using various styles of Font B 623 are displayed. Text sample 1060-A is shown in a “Normal” style, text sample 1060-B is shown in an “Extra-Bold” style and text sample 1060-C is shown in an “Italic” style. A developer may check the appropriate boxes to select one or more particular styles associated with a font. For example, in the illustrative embodiment, the developer may select the “Extra-Bold” style of Font B 623 by clicking on a “USE THIS STYLE” checkbox 1062 in region 1030.

The developer may also view and select styles, sizes, and other characteristics of other fonts displayed within other regions. In the illustrative embodiment, The developer selects the “NORMAL” style of Font C 624 by checking a “USE THIS STYLE” checkbox 1064 in second region 1031. Regions may be placed next to each other, side-by-side, one above another, etc. In other embodiments, regions 1030 and 1031 may be presented in a different manner.

In accordance with an embodiment, a developer may change the previewed text by using preview text option 1070. A developer may change the size of the text displayed within the regions by using a drop-down arrow 1025 under size option 1072. The text size may be measured in any unit including inches, meters, etc.; measurement in pixels “px” is shown for exemplary purposes only. Alternatively, a developer may change the size of the text by manually inputting a value for the text in region 1026.

In other embodiments, a developer may change letter spacing, word spacing or line height associated with text rendered using Font B and the text rendered using Font C. A developer may additionally underline the text rendered using Font B and the text rendered using Font C. The developer may change the text rendered using Font B and the text rendered using Font C from one line to a paragraph or from a paragraph to a line. A developer may further use script option 1071 to view and select one or more scripts associated with Font B and Font C.

Sample text and/or a predetermined phrase may be entered by default in preview text box 1070. Additionally, a plurality of predetermined phrases may be offered to the developer, and the developer may choose to view one of the predetermined phrases rendered using selected font(s). In one embodiment, the predetermined phrases may be offered in a drop-down menu 1027 or in an alternate manner.

A developer may wish to enter her own text and preview how it will be displayed once the text is rendered using selected fonts. In the illustrative embodiment, the developer enters the customized text, “Silly monkeys throw bananas” in preview text box 1070. Web developer device 104 transmits the customized text to webfont server 110. In response to receiving the customized text, webfont server 110 dynamically renders the generated phrase using the selected fonts. FIG. 10B shows a webpage 1091 on which the customized text is rendered in accordance with an embodiment. First region 1040 displays the customized text rendered using Font B 623 and second region 1041 displays the customized text rendered using Font C 624. In another embodiment, the dynamically generated phrase rendered using Font B 623 is displayed in a third region of the webpage, and the dynamically generated phrase rendered using FONT C 624 is displayed in a fourth region of the webpage.

In the illustrative embodiment, font B 623 has a plurality of styles including Normal and Extra-Bold; the customized text is rendered in the respective styles in sub-regions 1070A and 1070B.

In one embodiment, multiple styles associated with a font are displayed in the corresponding region automatically. In another embodiment, the font is displayed initially using a default style only. Other styles are displayed when the developer selects a styles option 1010.

In the illustrative embodiment, a pane 1011 includes additional manipulation options, such as a specimen option 1015, a styles option 1010, a test option 1012, a character set option 1013 and a description option 1014, is displayed.

A developer may select specimen tab 1015 to view text contained within regions as a heading rendered using a larger font size or as a paragraph with a smaller font size.

A developer may use character set tab option 1013 to view special characters or symbols rendered using a selected font. For example, the following characters or symbols may be included: ! @ # $ % A & * (. In one embodiment, upon selection of character set option 1013, an entire character set text is rendered using a first selected font adjacent the entire character set rendered using a second selected font.

A developer may use description option 1014 to view a description of selected fonts. A general description of a font may be included along with the font name, available font styles, font families, author of the font, etc. In one embodiment, a description associated with a first selected font and a description associated with a second selected font are displayed.

If at any time, a developer wishes to isolate a single font and view information about that particular font, the developer may select an option to display such information in a pop-out window. The pop-out window may include information about the single font and display various texts within a paragraph, single sentence, single word, character set, etc. rendered using the font. For example, a developer may press a button (not shown) within a region 1030 or 1031 that allows a pop-out window to appear.

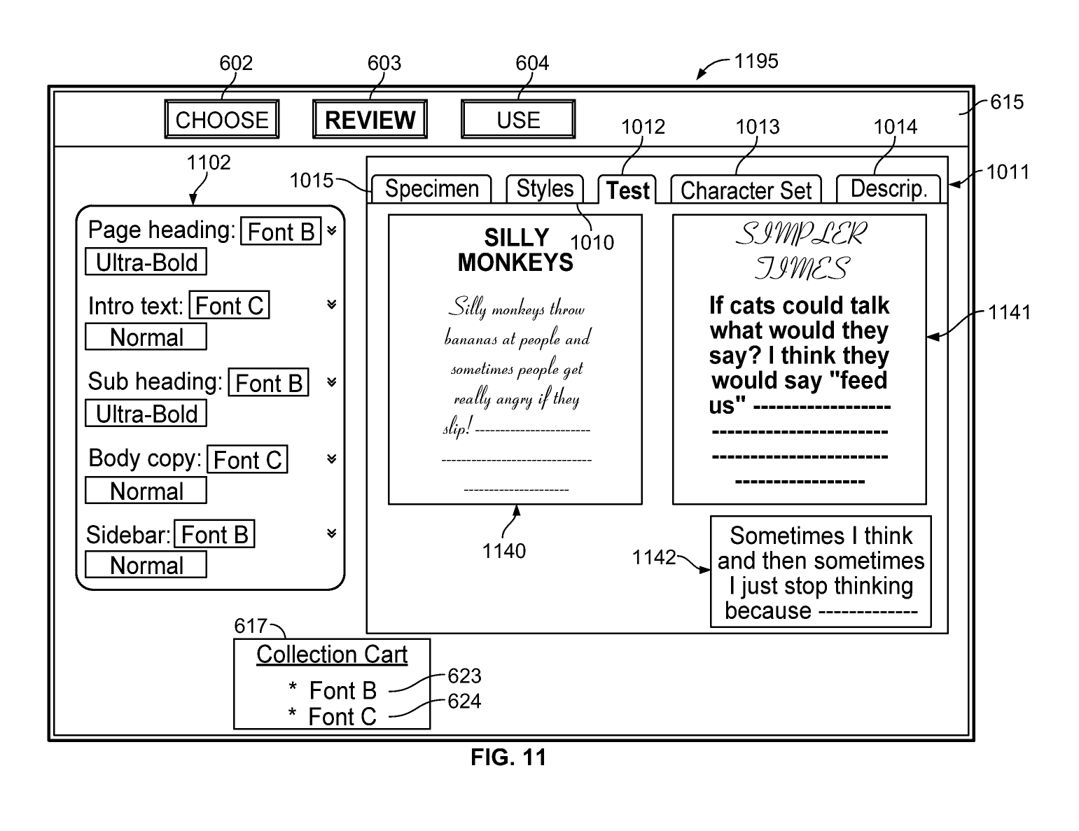

In the illustrative embodiment, supposing that the developer selects Test option 1012, a webpage such as webpage 1195 shown in FIG. 11 is displayed. The developer selects a first region 1140 and chooses various fonts and styles associated with Font B to be applied to a page heading, a paragraph, etc. Similarly, the developer selects a second region 1141 and chooses various fonts and styles associated with Font C to be applied to the page heading, the paragraph, etc. In the illustrative embodiment, the developer inputs selections relating to Font B and Font C for use in regions 1140 and 1142 in a pane 1102. In one embodiment, the developer may select at least one of rendering a selection of text using Font B in a third region and rendering another selection of text using Font C in the third region. Another selection of text may include at least one of a single word, a single heading, a single sentence and a paragraph. A developer may also choose to view a sidebar in a fourth region 1142 and render text within the sidebar using a selected font and style. In this way, a developer may test the selected fonts and view them as applied to a heading, a paragraph, etc.

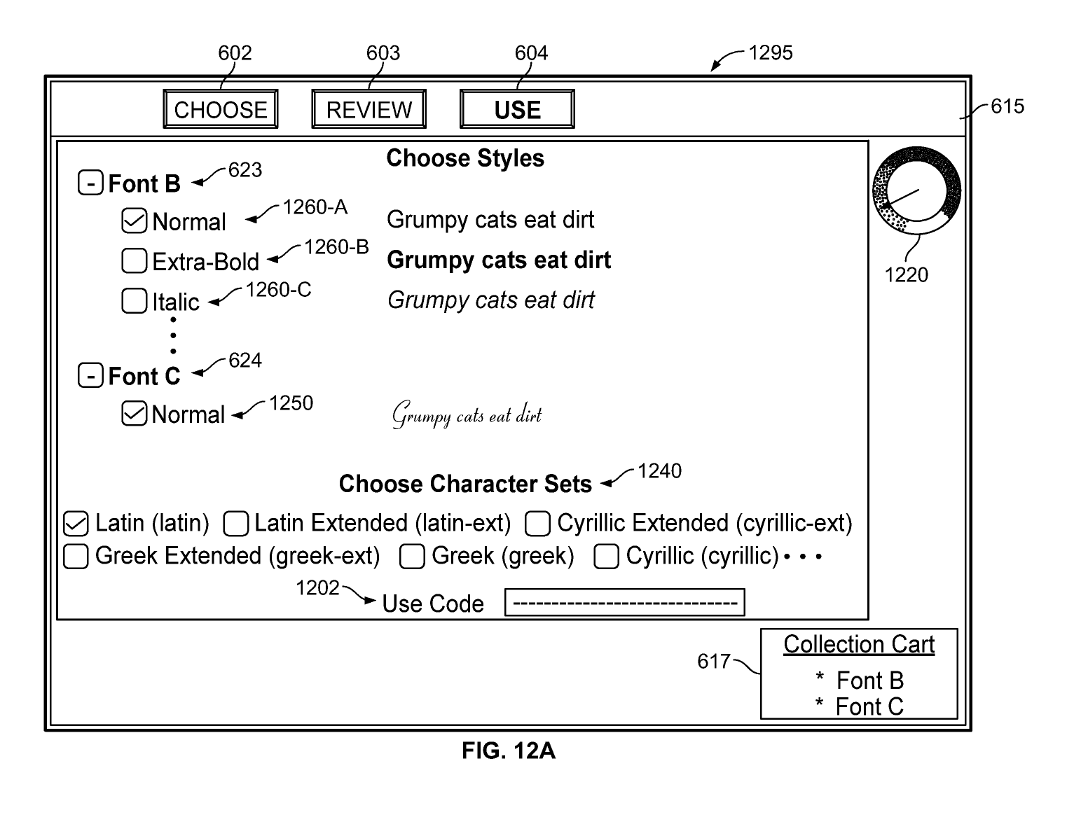

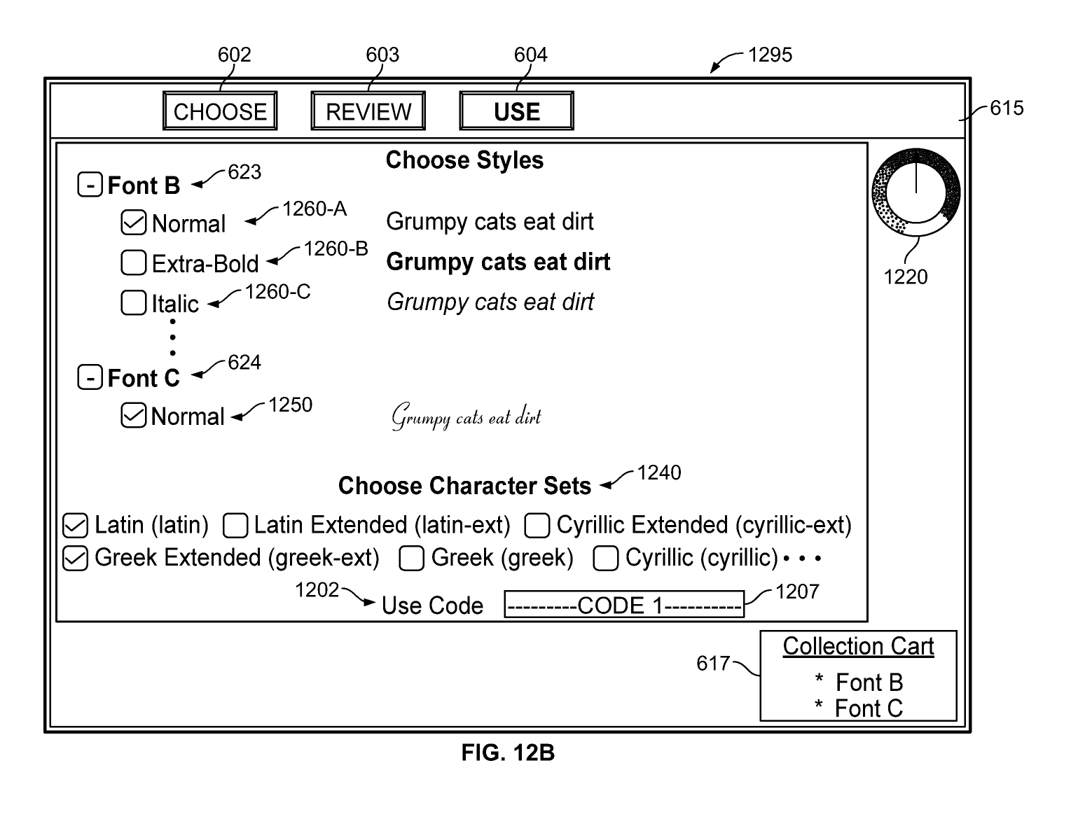

Supposing that the developer now selects styles option 1010 (in pane 1011), a webpage such as that shown in FIG. 12A is displayed. Webpage 1295 allows a developer to select one or more styles associated with the selected fonts.

According to an embodiment, at any point, the developer may return to a previous page by selecting “back” on her browser window. The developer may switch between choose button 602, review button 603 and use button 604 at any time. In one embodiment, toggling and/or switching between these buttons does not cause any information to be lost. For example, if the developer has entered customized text, as described above with respect to FIG. 10B, clicking away from the page containing the customized text does not cause deletion of the customized text. Rather, this text and other options that have been selected, including but not limited to font size, font style, boldness, etc., are kept cached and are accessible at any time.

In one embodiment, a developer may select an option to bookmark her font and style selections. In response, a uniform resource locator (“URL”) is provided. The URL contains a hyperlink to all options, selections, customization, etc. made by the developer when the developer (or someone else) clicks on the URL, the previous session and/or visit to the webfont website is restored.

Referring to FIG. 12A, webpage 1295 includes a plurality of options for choosing fonts, styles, character sets and an indicator 1220 of their effects on load time, in accordance with an embodiment.

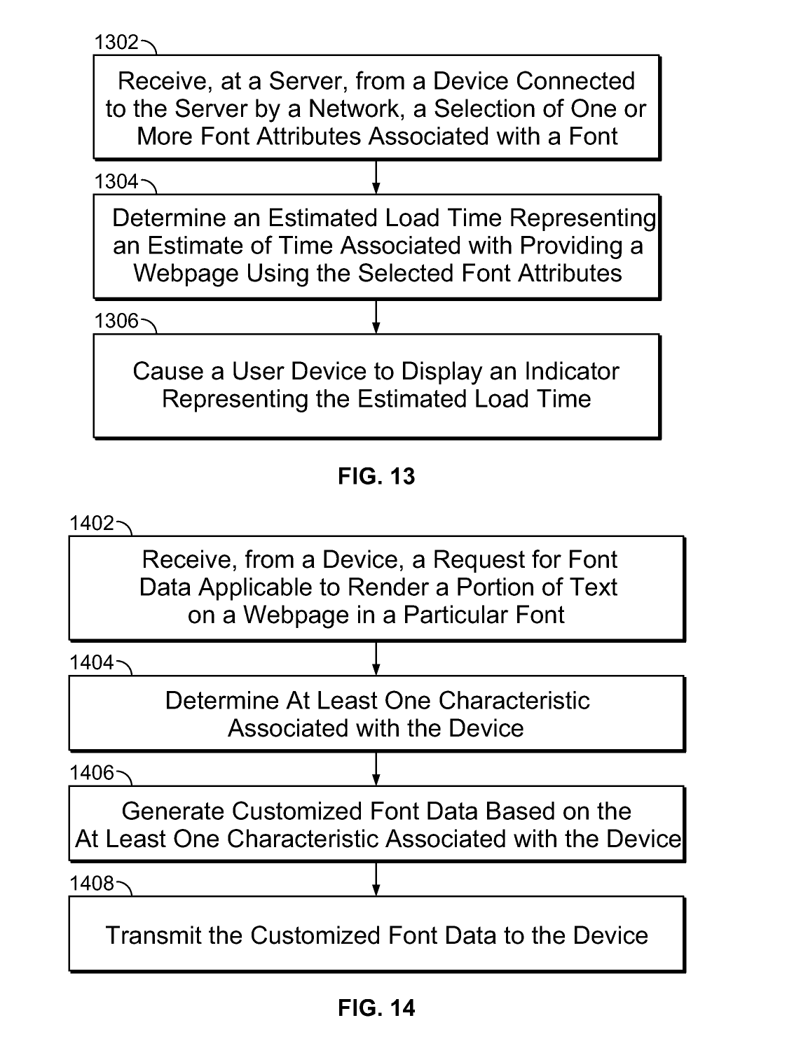

After the developer has finalized the selections of the fonts (in the illustrative example, the developer has selected Font B 623 and Font C 624) the developer may select various properties/attributes associated with the selected fonts that the developer wishes to use on the developer's webpage. In an embodiment, fonts, styles, character sets and other items associated with fonts are herein be referred to as font attributes. The selection of font attributes and their effects on load time are described herein with reference to FIG. 13.

FIG. 13 illustratively depicts a flowchart of a method of determining an estimated load time in accordance with an embodiment. At step 1302, a server receives, from a user device connected to the server by a network, a selection of one or more font attributes associated with a font. Webfont server 110 receives, from web developer device 104 connected to webfont server 110 by network 102, a selection of one of more font attributes (e.g. 1260-A, 1260-B, 1260-C) associated with Font-B 623. In an embodiment, font attributes comprise at least one of font styles and font character sets. For example, font attributes associated with font B 623 comprise font styles 1260-A, 1260-B, 1260C and font character sets 1240. In another embodiment, font attributes associated with font B 623 comprise a first font style italic 1260-C and a second font style Normal 1260-A.

In the illustrative example of FIGS. 12A and 12B, the developer may select from among style options, “Normal” 1260-A, “Extra-Bold” 1260-B and “Italic” 1260-C, for Font B 623 and style option “Normal” 1250 for Font C 624. Each style option 1260-A, 1260-B 1260-C, 1250, etc. may include sample text rendered using the corresponding font style. In the illustrative example, each style option includes a visual display of “Grumpy cats eat dirt” rendered using the respective styles.

A developer may select which styles to use by checking off a checkbox adjacent the style name. In the illustrative embodiment, the developer selects the “Normal” and “Extra-Bold” styles for Font B 623, but does not wish to use the italic version of Font B 623 and accordingly leaves the checkbox 1260-C adjacent “Italic” unchecked or unselected.

The developer may also select which character sets 1240 to include on webpage 108. For example, should the developer wish to use a “Latin” style, the developer may check off the checkbox adjacent “Latin (latin).” Other character sets are not selected.

At step 1304, an estimated load time representing an estimate of time associated with providing a webpage using the selected font attributes is determined. Webfont server 110 therefore determines an estimated load time associated with providing a webpage using the “Normal” and “Extra-Bold” styles for Font B 623.

At step 1306, a user device is caused to display an indicator representing the estimated load time. Webfont server 110 causes web developer device 104 to display indicator 1220. In an embodiment, the developer can see the impact of the selection of font attributes on load time and can then choose which attributes to use on the website, while paying attention to load time.

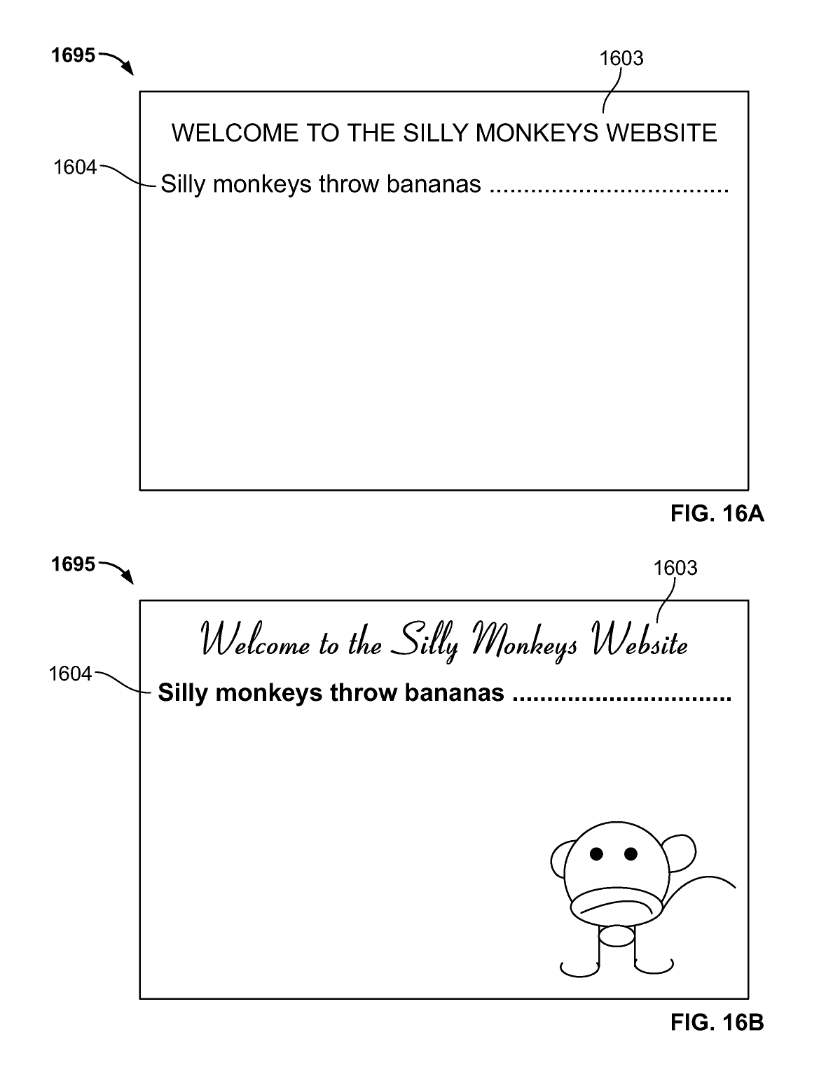

Indicator 1220 in FIGS. 12A and 12B shows an estimated load time representing an estimate of time associated with providing webpage (e.g. webpage 1695 in FIGS. 16A and 16B) on web developer website 108 using the selected font attributes (e.g. 1260-A, 1260-B, 1260-C). Indicator 1220A shows an estimated load time of the font file that is determined based on the developer's selection of font attributes including fonts, styles, character sets, etc. In the illustrative embodiment, as the developer selects various font attributes, an arrow on indicator 1220 is adjusted, substantially in real-time. In an embodiment, the lighter-shaded area of chart 1220 is indicative of a shorter load time and the darker-shaded area is indicative of a longer load time. In one embodiment, the information shown by indicator 1220 is a relative measurement of load time.

In an embodiment, the developer may select a second font style Italic 1260-C. A selection of the second font style, made by web developer device 104, is received by webfont server 110. Webfont server 110 determines an updated estimated load time 1220 in FIG. 12B representing an updated estimate of time associated with providing the webpage using the selected font attributes including the second font style Italic 1260-C. An updated indicator 1220 in FIG. 12B representing the updated estimated load time is provided to web developer device 104.

In an embodiment, a selection, made by the web developer, of the first font style Normal 1260-A is received at webfont server 110. A deselection of the second font style Italic 1260-C is then received at webfont server 110. Webfont server 110 determines a second updated estimated load time representing a second updated estimate of time associated with providing the webpage using the selected font attributes including the first font style Normal 1260-A. A second updated indicator representing the second updated estimated load time is provided to web developer device 104.

In an embodiment, the step of providing to the device, a second updated indicator is provided substantially in real-time, in response to receiving a selection of the first font style and receiving a deselection of the second font style.

In an embodiment, a size of stored data corresponding to the second font style is greater than a size of stored data corresponding to the first font style. For example, the size of stored data corresponding to the second font style Italic 1260-C may be larger or greater in size than a size of stored data corresponding to the first font style Normal 1260-A.

In an embodiment, the second updated indicator indicates a greater load time than the updated indicator. For example, indicator 1220 in FIG. 12-B indicates a greater load time than indicator 1220 in FIG. 12-A.

In an embodiment, indicator 1220 may comprises at least one of a numerical representation representing the estimated load time (not shown) and a graphical representation representing the estimated load time. Other representations not shown may also be used.

As shown in FIG. 12B, the developer has now selected an additional font style to include in his/her webpage by checking off the checkbox located adjacent Font B′s Italic style 1260-C. The developer has also selected an additional character set “Greek Extended (greek-ext)” under character sets selection 1240. After checking these options, load time indicator 1220 is adjusted to indicate a longer load time compared to the load time reflected by indicator 1220 in FIG. 12A. In one embodiment, a number showing the size of the font file may be displayed adjacent indicator 1220. A combination of time and size may be used to determine the estimated load time shown by indicator 1220. By using indicator 1220, a developer may chose font attributes for use on a webpage, while taking into consideration the impact they will have on the load time of the webpage.

When the developer has completed her selections, the developer may select use button 604 (in pane 615). For example, if use button 604 is selected, the developer may be provided with various options, shown by FIGS. 12A and 12B. Upon selection of use button 604, webfont server 110 generates a font file containing font data defining the selected fonts, and styles, sizes, etc., and also generates a code containing a reference to a font file. A code is displayed in a code field 1202. Alternatively, the developer may be provided with the code without selection of the use button 604. To generate a font file, webfont server 110 accesses webfont database 310 and retrieves data relating to the selected fonts, character sets, styles, sizes, etc. In one embodiment, the code is generated substantially in real-time and updated substantially in real-time based on the selection of fonts, character sets, etc. Referring to FIG. 12B, a code 1207 represented as “CODE-1” which includes a reference to a font file containing the developer's selected fonts, styles, sizes, etc., is displayed in field 1202.

Once a developer is satisfied with her selection of font(s), the developer may choose to download the selected fonts and/or styles for use on a website. For example, a developer may download the selected fonts and/or styles directly onto the developer's device. For example, the developer may acquire all the fonts and/or styles chosen by downloading a file containing font data defining the fonts and/or styles (e.g. a compressed file). The fonts and styles may then be used to build a website. In an embodiment, a developer may use selected fonts by referencing them on a webpage. Using this method obviates the need to download a file containing the fonts and/or styles.

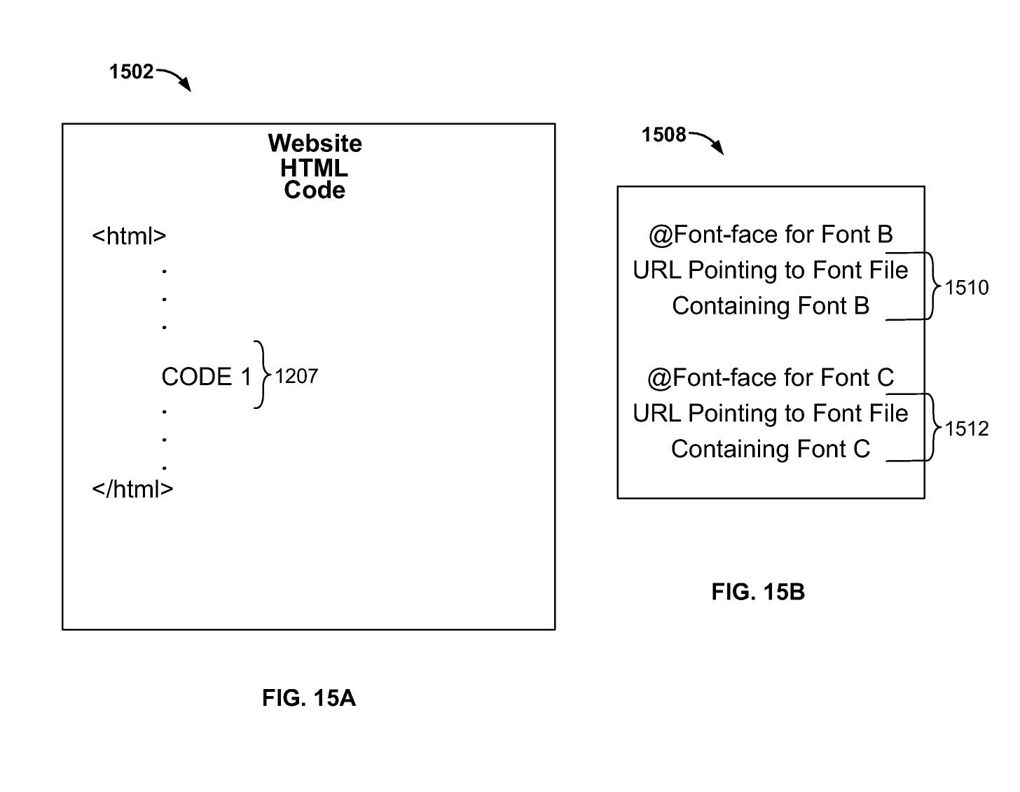

Alternatively, after a developer has selected the fonts, styles, scripts, etc., desired for building a webpage, the developer may copy the code provided in use code field 1202 and use it to build the webpage. For example, the developer may copy CODE-1 (1207) and include it in a webpage as the developer builds web site 108. FIG. 15A shows an example of a webpage 1502 which may be part of website 108 in accordance with an embodiment. Code 1207 has been inserted within webpage 1502. FIG. 15A is discussed in more detail below.

In one embodiment, the code is dynamically generated based on the developer's selection of fonts, styles, scripts, etc. For example, the code may be hypertext markup language (HTML) code that may be included within webpage code. Alternatively, the code may be @import code or JavaScript code. In accordance with one embodiment, a developer is offered the option of choosing from among of these types of codes. For example, a developer may toggle between the various codes by selecting between a first tab corresponding to the HTML code, a second tab corresponding to the @import code and a third tab corresponding to the JavaScript code. These codes may be generated and displayed substantially in real-time upon selection of the corresponding tab.

In one embodiment, a code is provided that may be copied and pasted within the code of a webpage (e.g. HTML code) within the <head> tag. The generated code may contain a Hypertext Reference (HREF) to a Uniform Resource Locator (URL) associated with a file containing font data defining the selected fonts and styles. A developer may then further define one or more of the selected fonts within the <style> tag, which define how to display HTML elements. In one embodiment, the generated code may contain a <link> tag including a reference to a URL of a website that contains an @font-face rule (or font data) defining the selected fonts. In one embodiment, the URL links to a file containing the font data maintained by webfont server 110. The font data may include an @font-face rule defining the selected font families, styles, weights, etc.

In some embodiments, the code is linked to a cascading style sheet (CSS) that defines the selected fonts and styles. In one embodiment, a style associated with a selected font may be defined in a stylesheet. In another embodiment, a style associated with a selected font may be defined within an inline style on the element itself.

When specifying a font in a CSS style, a developer may list at least one fallback web-safe font such as “safe font” in order to avoid unexpected behaviors in case the developer's selected font (i.e. “Font C”) is unable to render the text on the developer's website. In this way, the browser may fall back to its default fonts (i.e. “safe font”) if necessary.

By using a CSS, the styles associated with one or more fonts may be changed. For example, a shadow may be added to certain text and when that text is rendered for display, a shadow is displayed, as defined in the CSS.

An @font-face rule may contain a reference to a second URL that contains a font file containing one of the fonts. Similarly, for each font selected by the developer, there may be a respective reference to a URL associated with a font file containing the selected font. The URLs may link to webpages or files hosted by any server having a database of all the fonts.

FIG. 15A shows website HTML code associated with a webpage 1502, which may be a webpage on web developer website 108, for example, in accordance with an embodiment. The HTML code contains CODE-1 (1207), which itself contains a URL link 1404. The URL link 1404 points to a file 1508 shown in FIG. 15B. File 1508 contains information relating to selected fonts. For example, when browser 316 interprets the HTML code of webpage 1502, browser 316 obtains CODE-1 (1207) and transmits to webfont server 110 a request for access to file 1508. File 1508 may be stored on webfont server 110, in one embodiment. In another embodiment, file 1508 may be stored remotely.

File 1508 may contain @font-face rules for selected Font B and Font C. The pseudo-code shown in FIG. 15B shows that the @font-face rule for Font B contains a URL pointing to a font file that contains Font B 1510 and the @font-face rule for Font C contains a URL pointing to a font file that contains Font C 1512. The font files may be stored on webfont server 110, in one embodiment. In another embodiment, the font files may be stored remotely.

When an end user device accesses webpage 1502, the end user device obtains CODE-1 (1207) and uses the URL contained therein to access the corresponding font file stored at webfont server 110. Specifically, the end user device interprets HTML code of the website, reads the code and the URL, and transmits to webfont server 110 a request for corresponding font data that will be used to render text contained within website 108.

In another embodiment, webfont server 110 determines a characteristic of a requesting device and provides a customized font file to the device based on the characteristic. Webfont server 110 retrieves pertinent font-related data from webfont database 310 in memory 308. For example, in response to receiving a request for font data, webfont server 110 may determine various characteristics associated with the mobile device. For example, webfont server 110 may determine that the requesting party is a mobile device using a mobile browser to access the website and determine the operating system of the mobile device. Webfont server 110 then generates a font file based on the selected fonts, styles, character sets, sizes, etc., in the manner described above, and selects only a portion of the generated font file to transmit to the mobile device, based on the one or more determined characteristics. FIG. 14 is a flowchart of a method for generating customized font data in accordance with an embodiment.

At step 1402, a request from a device for font data applicable to render a portion of text on a webpage in a particular font is received. Thus, webfont server 110 receives the request for font data from browser 316 of end user device 114.

At step 1404, at least one characteristic associated with the device is determined. In the illustrative embodiment, webfont server 110 determines one or more characteristics of end user device 114. Webfont server 110 may determine the type of the requesting device based on information in the request. For example, webfont server 110 may determine that the requesting device is a mobile device. In one embodiment, webfont server 110 may sniff the packets associated with the request to determine one or more characteristics. Other characteristics associated with the user's device and/or browser may include a name and/or type of a browser, a version of the browser, an operating system of the user's device (including mobile device operating systems), a resolution of the screen used to access the website, a location of the user using the device, a name of the host Internet service provider (ISP), an Internet protocol (IP) address of the device, etc.

In one embodiment, while webfont server 110 is identifying characteristics associated with user device 114, webfont server 110 causes browser 316 to display a webpage using one of more default fonts. FIG. 16A shows a webpage 1695 on which a header 1603 and a sentence 1604 are displayed in a default font.

At step 1406, customized font data is generated based on the at least one characteristic associated with the device. In one embodiment, if it is determined that the end user device is a mobile device, font data containing only a portion of the selected fonts may be generated. In one embodiment, webfont server 110 receives data indicating that the user device is a mobile device, in a manner as described above. Webfont server 110 generates the requested font file, for example, by retrieving the pertinent data from webfont database 310 in memory 308. As webfont server 110 has determined that the recipient of the customized font file is a mobile device, webfont server 110 may automatically reduce the size of the font data (e.g. by excluding certain glyphs, styles, etc.) prior to transmitting the customized font data to the mobile device. In this way, not only is the customized font data first customized by the web developer to include certain selected font styles but is further customized (e.g. to reduce the font data size) for the mobile device. In one embodiment, webfont server 110 customizes font data selected by the web developer and customizes font data based on one or more characteristics of the user device prior to sending the customized font data to the user device. In one embodiment, font data containing only half of the selected fonts may be generated. In this way, the webpage may load faster on the mobile device.

At step 1408, the customized font data is transmitted to the end user device. Accordingly, webfont server 110 transmits the font data to end user device 114. In one embodiment, the generated font data transmitted to a mobile device may differ from the font data transmitted to a non-mobile device. In another embodiment, the generated font data transmitted to a device running a first operating system may be different than the generated font data transmitted to a second device running a second operating system.

End user device 114 receives the font data and uses it to render the webpage associated with website 108. Once the font files containing the fonts are received, the fonts are cached by browser 316. Text contained on website 108 is then rendered using the appropriate font.

FIG. 16B shows webpage 1695 rendered using selected fonts retrieved from webfont server 110 in accordance with an embodiment. In particular, text 1603 and 1604 are now rendered using the selected fonts. When a user clicks on different webpages within website 108, text on various pages is similarly rendered using the appropriate fonts.

A second device may request font data from the webfont server 112. The webfont server receives the second request for font data to render the portion of the text on the webpage. The server determines a characteristic associated with the second device. For example, the server may determine, through sniffing the request packets, that the second device is running a first operating system. The server then dynamically generates second font data based on the first operating system of the second device. The server then transmits the second font data to the second device, which may be different than the font data transmitted to the mobile device in the example described above, so that the second device may view the rendered text on display.

In one embodiment, the second device may be a wireless device and the transmitted, second font data is smaller in size than the transmitted font size data to the first device. In another embodiment, the second font data is different from the font data.

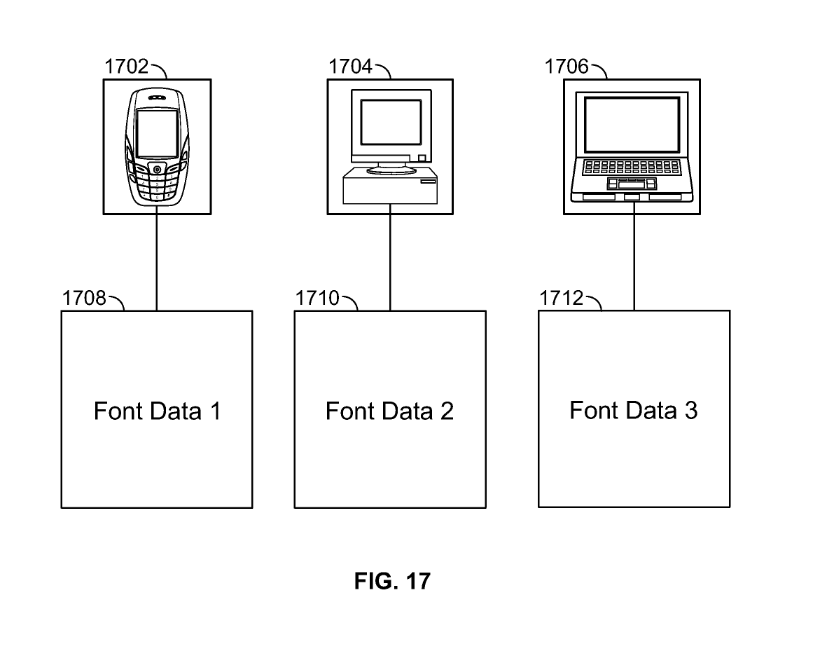

FIG. 17 shows different font data associated with various devices in accordance with an embodiment. A first device 1702 may be a mobile device, a cell phone, a personal digital assistant (PDA), a tablet, a netbook, an electronic book reader, or the like. A second device 1704 may be a personal computer running a first operating system. A third device 1706 may be a laptop running a second operating system. The font data generated for each device is dynamically generated based on characteristics associated with that device. Therefore, “Font Data 1” 1708 generated for the first device 1702 may be different than “Font Data 2” 1710 generated for the second device 1704 and “Font Data 3” 1712 generated for the third device 1706 may be different than other generated font data. Each font data may be specific to the browser and/or operating system associated with the device.

In accordance with an embodiment, dynamic sub setting of font data is performed to provide customized font data for an end user device. In one embodiment, a generic font file is dynamically generated based on the input of the developer, including the selections of fonts, styles, sizes, etc. When a user accesses website 112, webfont server 110 modifies the generic font file to better suit the user's browser, operating system, etc. Providing dynamic sub-setting of font data may enhance the user's experience on the website. For example, if the user accesses website 112 using a mobile browser, the load time required to view a webpage of the website may be reduced using dynamically generated font data as compared to the generic font data. Additionally, the file size of the font data may be decreased as compared to the generic font data.

In order to modify a generic font file, the file format is changed. Based on the determined characteristics associated with the user device, extraneous information or data that is not needed may be removed. For example, some operating systems do not support certain glyphs. If it determined that the user's device is running an operating system not supporting certain glyphs, the corresponding glyph data may be dynamically removed from the font data, and only glyphs that are supported may be included. Therefore, when a request to view website 112 is received from end user device 114, only glyphs supported by the user's operating system and/or browser are included in the font data.

Some operating systems may strip hints associated with fonts (font hints) while other operating systems may support font hints in order to enhance the display of characters. In one embodiment, if a certain operating system has been detected by the webfont server 110, and it is determined and/or otherwise known that the operating system strips font hints, the hints are dynamically removed before the font data is sent to the user's device. According to this embodiment, removal of hints in the font data is performed based on the operating system.

According to another embodiment, a web developer may manually specify certain characters, hints, glyphs, etc. that the developer wishes to be included on the font data. In another embodiment, an end user may request only certain characters, hints, glyphs, etc. In response to the request, webfont server 110 includes only the requested characters, hints, glyphs, etc. associated with the fonts in the font data.

In order to optimize the appearance of a font, some browsers support more than one font format. The dynamic sub-setting of font data chooses an optimal font configuration based on the user's operating system and browser combination.

Some operating systems and/or browsers strip metadata associated with fonts and/or characters. For example, some operating systems and/browsers may support characters but do not contain hints, metadata, etc. associated with the characters.

According to an embodiment, website 112 may include advertisements, and may use a limited number of unique characters associated with a font to render text in an advertisement. For example, an advertisement may contain a logo, heading and a one sentence catch-phrase. Therefore, it may be inefficient for the developer to include all characters associated with all the fonts used on the website. Thus, the developer may decide to request only the characters that are actually used on his/her web site instead of the entire subset of characters associated with the font. In such an embodiment, the developer may specify a text=value in reference URL containing the font data. In response to receiving a request for the font data, webfont server 110 returns a font file optimized to the request specified in the text=value. The developer may specify the text=value manually or by using the application programming interface (API) described above and shown by FIGS. 6-8, 10A, 10B, 11, 12A and 12B. In one embodiment, a developer may be provided with a selection of characters associated with one or more fonts in the API.

In the illustrative embodiment, if the developer uses only Font C to display the title of the website, only a limited number of characters in the subset of Font C may be needed. The developer may place the value of the title itself as the value of the text=. For example, the request for the title having Font C rendering the title, may include the following sample HTML code:

fonts.WebFontServer.com/css?family=Font+C&text=Welcome%20to%20the%20Silly%20Mon keys%20Website

In one embodiment, as with all query strings, the developer may URL-encode the value. The text=feature may also work for international fonts, allowing specification of Universal Character Set Transformation Format—8-bit (UTF-8) characters. For example, supposing that the developer wishes to display the title of the developer's webpage (“Hello”) rendered using Font B in Spanish as “!Hola!”, the request for the title may include the following sample HTML code:

fonts.WebFontServer.com/css?family=Font+B&text=%c2%alHola!

A developer may not need to specify the subset=parameter when using text=because the text=parameter allows a developer to refer to any characters in the original font. Using only a select group of characters as opposed to the entire subset of characters associated with a font may help to reduce significantly the size of the font file. Therefore, in one embodiment, the size of the font data, load time, etc. depends on the browser and operating system used by the end user device and whether the developer has submitted the text=parameter.

In one embodiment, when a user wishes to access website 112, the end user device sends a request for font data. The request includes a portion of a subset of characters associated with a font referred to in the font data if the developer selects a portion of characters (e.g. the following characters: A, E, G, I, K, L, M, N, 0, R, S, T, W and Y which make up the phrase WELCOME TO THE SILLY MONKEYS WEBSITE). The request may include the entire subset of characters associated with a font referred to in the font data. The request for font data may include a reference to a font file containing the font.

In various embodiments, the method steps described herein, including the method steps described in FIGS. 5, 9, and 13, may be performed in an order different from the particular order described or shown. In other embodiments, other steps may be provided, or steps may be eliminated, from the described methods.

Systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be used within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the method steps described herein, including one or more of the steps of FIGS. 5, 9, and 13. Certain steps of the methods described herein, including one or more of the steps of FIGS. 5, 9, and 13, may be performed by a server or by another processor in a network-based cloud-computing system. Certain steps of the methods described herein, including one or more of the steps of FIGS. 5, 9, and 13, may be performed by a client computer in a network-based cloud computing system. The steps of the methods described herein, including one or more of the steps of FIGS. 5, 9, and 13, may be performed by a server and/or by a client computer in a network-based cloud computing system, in any combination.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIGS. 5, 9 and 13, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

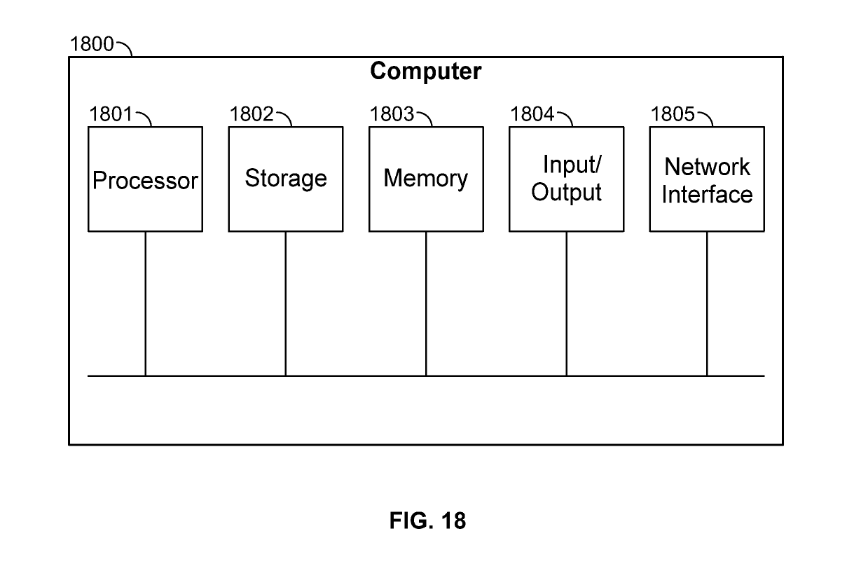

FIG. 18 is a high-level block diagram of an exemplary computer that may be used for implementing recursive embedding by URL parameterization. Computer 1800 comprises a processor 1801 operatively coupled to a data storage device 1802 and a memory 1803. Processor 1801 controls the overall operation of computer 1800 by executing computer program instructions that define such operations. The computer program instructions may be stored in data storage device 1802, or other computer readable medium, and loaded into memory 1803 when execution of the computer program instructions is desired. Thus, the method steps of FIGS. 5, 9, 13 and 14 can be defined by the computer program instructions stored in memory 1803 and/or data storage device 1802 and controlled by processor 1801 executing the computer program instructions. For example, the computer program instructions can be implemented as computer executable code programmed by one skilled in the art to perform an algorithm defined by the method steps of FIGS. 5, 9, 13 and 14. Accordingly, by executing the computer program instructions, the processor 1801 executes an algorithm defined by the method steps of FIGS. 5, 9, 13 and 14. Computer 1800 also includes one or more network interfaces 1805 for communicating with other devices via a network. Computer 1800 also includes one or more input/output devices 1804 that enable user interaction with computer 1800 (e.g., display, keyboard, mouse, speakers, buttons, etc.).

Processor 1801 may include both general and special purpose microprocessors, and may be the sole processor or one of multiple processors of computer 1800. Processor 1801 may comprise one or more central processing units (CPUs), for example. Processor 1801, data storage device 1802, and/or memory 1803 may include, be supplemented by, or incorporated in, one or more application-specific integrated circuits (ASICs) and/or one or more field programmable gate arrays (FPGAs).

Data storage device 1802 and memory 1803 each comprise a tangible non-transitory computer readable storage medium. Data storage device 1802, and memory 1803, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 1805 may include peripherals, such as a printer, scanner, display screen, etc. For example, input/output devices 1804 may include a display device such as a cathode ray tube (CRT), plasma or liquid crystal display (LCD) monitor for displaying information to the user, a keyboard, and a pointing device such as a mouse or a trackball by which the user can provide input to computer 1800.

Any or all of the systems and apparatus discussed herein, may be implemented using a computer such as computer 1800.

One skilled in the art will recognize that an implementation of an actual computer or computer system may have other structures and may contain other components as well, and that FIG. 18 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method comprising:
displaying simultaneously on a webpage a text rendered using a first font in a first region of a display and the text rendered using a second font in a second region of the display, wherein the text rendered using the first font includes at least a first subset of the first font and the text rendered using the second font includes at least a second subset of the second font;
providing an option to manipulate the text rendered using the first font and the text rendered using the second font;
in response to a selection of the option, manipulating the text rendered using the first font and the text rendered using the second font;
selecting at least one of the first subset of the first font and the second subset of the second font displayed in the first region and the second region of the display;
generating a font file corresponding to the selected subset of the at least one of the first font and the second font; and
displaying a code associated with the font file corresponding to the selected subset of the first font and the second font.

2. The method of claim 1 wherein the option to manipulate includes at least one of:
changing the size of the text rendered using the first font and the text rendered using the second font;
changing a letter spacing associated with the text rendered using the first font and the text rendered using the second font;
changing a word spacing associated with the text rendered using the first font and the text rendered using the second font;
changing a line height associated with the text rendered using the first font and the text rendered using the second font;
underlining the text rendered using the first font and the text rendered using the second font;
changing the text rendered using the first font and the text rendered using the second font from one line to a paragraph;
changing the text rendered using the first font and the text rendered using the second font from a paragraph to a line; and
selecting a script associated with the text rendered using the first font and the text rendered using the second font.

3. The method of claim 1 further comprising:
displaying a character set text rendered using the first font adjacent the character set text rendered using the second font.

4. The method of claim 1 further comprising:
displaying a description associated with the first font and a description associated with the second font in response to input instructions.

5. The method of claim 1 wherein the text comprises one of a predetermined phrase and a dynamically generated phrase.

6. The method of claim 5 further comprising:
receiving the dynamically generated phrase; and
in response to receiving the dynamically generated phrase, displaying simultaneously on the webpage the dynamically generated phrase rendered using the first font in a third region of the webpage, and the dynamically generated phrase rendered using the second font in a fourth region of the webpage.

7. The method of claim 1 wherein a second text in a third region is rendered using at least one of the first font and the second font.

8. The method of claim 7 wherein the second text comprises at least one of a single word, a single heading, a single sentence, and a paragraph.

9. The method of claim 1 further comprising:
displaying a font attribute associated with one of the first font or the second font.

10. A non-transitory computer readable medium having program instructions stored thereon, the instructions capable of execution by a processor and defining the steps of:
displaying simultaneously on a webpage a text rendered using a first font in a first region of a display and the text rendered using a second font in a second region of the display, wherein the text rendered using the first font includes at least a first subset of the first font and the text rendered using the second font includes at least a second subset of the second font;
providing an option to manipulate the text rendered using the first font and the text rendered using the second font;
in response to a selection of the option, manipulating the text rendered using the first font and the text rendered using the second font; selecting at least one of the first subset of the first font and the second subset of the second font displayed in the first region and the second region of the display;
generating a font file corresponding to the selected subset of the at least one of the first font and the second font; and
displaying a code associated with the font file corresponding to the selected subset of the at least one of first font and the second font.

11. The non-transitory computer readable medium of claim 10 wherein the option to manipulate includes at least one of:
changing the size of the text rendered using the first font and the text rendered using the second font;
changing a letter spacing associated with the text rendered using the first font and the text rendered using the second font;
changing a word spacing associated with the text rendered using the first font and the text rendered using the second font;
changing a line height associated with the text rendered using the first font and the text rendered using the second font;
underlining the text rendered using the first font and the text rendered using the second font;
changing the text rendered using the first font and the text rendered using the second font from one line to a paragraph;
hanging the text rendered using the first font and the text rendered using the second font from a paragraph to a line; and
selecting a script associated with the text rendered using the first font and the text rendered using the second font.

12. The non-transitory computer readable medium of claim 10 further comprising instructions defining the step of:
displaying a character set text rendered using the first font adjacent the character set text rendered using the second font.

13. The non-transitory computer readable medium of claim 10 further comprising instructions defining the step of:
displaying a description associated with the first font and a description associated with the second font in response to input instructions.

14. The non-transitory computer readable medium of claim 10 wherein the text comprises one of a predetermined phrase and a dynamically generated phrase.

15. The non-transitory computer readable medium of claim 14 further comprising instructions defining the steps of:
receiving the dynamically generated phrase; and
in response to receiving the dynamically generated phrase, displaying simultaneously on the webpage the dynamically generated phrase rendered using the first font in a third region of the webpage, and the dynamically generated phrase rendered using the second font in a fourth region of the webpage.

16. The non-transitory computer readable medium of claim 10 further comprising instructions defining the step of:
rendering a second text in a third region using at least one of the first font and the second font.

17. The non-transitory computer readable medium of claim 16 wherein the second text comprises at least one of a single word, a single heading, a single sentence, and a paragraph.

18. The non-transitory computer readable medium of claim 10 further comprising instructions defining the step of:
displaying a font attribute associated with one of the first font or the second font.
